(19) United States
(12) Patent Application Publication
(10) Pub. No.: US 2019/0279225 A1
(43) Pub. Date: Sep. 12, 2019

(54) Anti-Boycott Compliance Software

(71) Applicant: Lila Ann Rose, North Olmsted, OH (US)

(72) Inventor: Lila Ann Rose, North Olmsted, OH (US)

(21) Appl. No.: 14/883,514

(22) Filed: Oct. 14, 2015

(51) Int. Cl. G06Q 30/00; G06F 17/27; G06Q 50/26; G06Q 30/02

(52) U.S. Cl. CPC G06Q 30/018; G06Q 30/0201; G06Q 50/26; G06F 17/2765

(57) ABSTRACT

The Anti-Boycott Compliance Software will provide automation for organizations to comply with U.S. anti-boycott regulations from the Department of Commerce Bureau of Industry and Security (BIS) and the Internal Revenue Service (IRS). The software transforms a current manual process with the large potential for human error to an automated process that flags boycott risks, scans relevant documents for boycott language, reports the language internally, and creates and sends the legally required external reports. The software maintains a database of boycott cases and language that is updated regularly to ensure continued compliance with U.S. regulations, and also maintains an audit trail for users.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The Department of Commerce Bureau of Industry and Security (BIS) and the Internal Revenue Service (IRS) both have anti-boycott regulations. These agencies prohibit U.S. persons (individuals and organizations) from complying with unsanctioned economic boycotts, such as the Arab League Boycott of Israel. U.S. persons are required to decline participation in these boycotts and to report any boycott language found in documents they receive, including: Purchase Orders, Letters of Credit, Contracts, Terms and Conditions, and others. BIS requires a quarterly report with all boycott language received during the quarter while the IRS requires an annual report.

### BRIEF SUMMARY OF THE INVENTION

This invention is a software program that automates anti-boycott compliance by interfacing with an organization's existing software to flag, screen, and report boycott language.

### DETAILED DESCRIPTION OF THE INVENTION

### Current State

Currently, there is no software solution for this type of compliance. Organizations use manual processes that require a person to read through documents to look for boycott language. If the language is found, it is normally reported to the company's legal department, who may decide what action should be taken and who will record the language for submission in quarterly or annual reports. This process has several flaws, including:

1. Large potential for human error
a. The person scanning may not recognize boycott language
b. The person scanning may accidentally miss the boycott language
c. The documents can be very long
d. Many different phrases can be boycott language and may not be obvious
e. The legal department may not be familiar with anti-boycott laws
f. The internal notification of boycott language could be missed or ignored
g. The legal department must manually file the quarterly report, which could be missed or ignored

2. Boycott language is not always obvious
a. Many examples of boycott language do not include a specific country
b. Can be positive statements vs. negative statements
c. Could result in the person scanning making a judgement call, which may be incorrect
d. The legal department may make a judgement call, which may be incorrect

3. Requires manually creating an audit trail
a. Emails, memos, or other correspondence must be compiled into an audit record
b. Internal reports must be manually compiled into the external report

Software solutions for other types of compliance do exist and are commonly used; these include: Restricted Party Screening/Denied Party Screening (RPS), which scans parties from an organization's Enterprise Resource Planning (ERP) system against government list of debarred or blocked parties to comply with the U.S. Department of Treasury Office of Foreign Assets Control (OFAC); and Adverse Media Screening, which scans parties against a database of news stories for reports of corruption or bribery to comply with the Foreign Corrupt Practices Act (FCPA).

As a current practitioner of trade compliance, I conducted research on anti-boycott compliance tools through internet searches and discussions with providers and users of existing compliance software and found no evidence of automated solutions for anti-boycott compliance. A search of existing patents using various keywords also returned no results.

### Improvements

This software improves the process from its current state by drastically reducing the human error factor. While the software does still require a human to upload the relevant documents, the following steps are changed from manual (human) to automated (software):

1. Flagging customers, suppliers, and transactions as boycott risks

2. Prompting for anti-boycott scanning

3. Scanning documents for boycott language

4. Maintaining knowledge of boycott countries and language

5. Reporting boycott language internally

6. Compiling boycott reports

7. Sending boycott reports externally

8. Maintaining an audit trail

The anti-boycott compliance software will provide a single interface for users to conduct anti-boycott compliance. The software will:

1. Scan the uploaded documents for boycott language
a. Allow for document uploads in multiple formats
b. Display any hits with reference to the regulation or case where the language appears

2. Allow for escalation of the hit to a manager or another department such as legal

3. Flag any customers, suppliers, or transactions for boycott risk countries
a. Prompt the user to upload documents for flagged customers, suppliers, or transactions

4. Record any confirmed hits with the date of the hit

5. Automatically compile the required BIS quarterly report
a. Prompt the user to sign and file the BIS quarterly report
b. Send the quarterly report to BIS

6. Automatically compile information for the annual IRS report
a. Send the information to the internal user for the annual IRS report
b. Allow configuration of the information gathered, the date to be sent, and the contact to receive the information

7. Maintain records of hits, confirmations, and reports
a. Allow the user to set a record retention schedule to only keep records within the statute of limitations

### Requirements

Creating the software will require one or more software engineers or computer programmers to write the software code. Data for the boycott language, cases, regulations, and countries will be compiled using publically available government websites. Boycott violations dating back to 2007 are currently available and it is possible that additional cases may be made available by request. An interface with ERP systems would also be required and would be part of the setup to be performed when the software is purchased and installed.

### Components

1. User Interface
2. Interface with ERP system
3. Interface with the internet (for sending reports and updating databases)
4. Database of relevant IRS and BIS regulations
5. Database of boycott cases with boycott language
6. Database of general boycott language
7. Database of recorded boycott hits with confirmation or denial and dates
8. Database of quarterly reports with completion, signature, and sent dates
9. Database of annual report information
10. Database of boycott countrics
11. Quarterly and annual report templates

1. A software program that automates anti-boycott compliance by interfacing with an organization's existing software to flag, screen, and report boycott language; consists of a user interface, databases of boycott information for screening; templates for reporting; an interface with other software systems; an interface with the internet; and databases of software activity for recordkeeping.
